(19) United States
(12) Patent Application Publication
(10) Pub. No.: US 2025/0043111 A1
(43) Pub. Date: Feb. 6, 2025

(54) SOLID-LIQUID BI-PHASE LUBRICATING DEVICES AND METHODS OF USING SAME

(71) Applicant: P&S GLOBAL HOLDING LLC, Houston, TX (US)

(72) Inventors: Parash KALITA, Houston, TX (US); Jody WILLIAMS, Houston, TX (US); Francisco SALDANA, Houston, TX (US)

(73) Assignee: P&S GLOBAL HOLDING LLC, Houston, TX (US)

(21) Appl. No.: 18/718,052

(22) PCT Filed: Dec. 16, 2022
(86) PCT No.: PCT/US22/53258

§ 371 Date: Jun. 9, 2024

Related U.S. Application Data
(60) Provisional application No. 63/291,739, filed on Dec. 20, 2021.

(51) Int. Cl. C08K 13/04; B61K 3/02; C08K 3/04; C08K 5/09; C08K 7/00; C08L 23/06; C08L 67/06; C08L 91/06; C10M 105/06; C10M 107/02; C10M 117/00; C10M 169/02; C10N 50/10; F16N 11/00

(52) U.S. Cl. CPC C08K 13/04; B61K 3/02; C08L 23/06; C08L 67/06; C08L 91/06; C10M 105/06; C10M 107/02; C10M 117/00; C10M 169/02; F16N 11/00; C08K 3/042; C08K 5/09; C08K 7/00; C08K 2201/005; C08K 2201/011; C08L 2205/025; C08L 2205/035; C08L 2205/06; C08L 2207/066; C08L 2207/322; C10M 2203/065; C10M 2205/0206; C10M 2207/106; C10N 2050/10

(57) ABSTRACT

Disclosed herein are solid-liquid bi-phase lubricating devices that can include a cuboidal shaped stick with at-least one cylindrical or cuboidal shaped hollow core running through entire or partial length of the stick. The cuboidal shaped stick can include a solid polymer-based composite while the inner space is filled with a semi-fluid grease lubricant. The solid polymer-based composite can include one or more polymers, filler materials, corrosion inhibitors, plasticizers, and additives. The grease lubricant can include lithium, lithium-complex, aluminum-complex, calcium-sulphonate complex, bentone-thickened grease, and mixtures thereof and have an NLGI consistency grade≥1. The lubricating devices can be used for friction reduction of mechanical components involving two or more contacting surfaces in relative motion, such as a steel wheel flange-rail contact interface of transit and freight rail transport systems.

### CROSS-REFERENCE TO RELATED APPLICATIONS

This application claims benefit of priority under 35 U.S.C. § 119(e) of U.S. Ser. No. 63/291,739, filed Dec. 20, 2021, the entire contents of which is incorporated herein by reference in its entirety.

### BACKGROUND

### Field

Disclosed herein are solid-liquid bi-phase lubricating devices and methods for applying lubricating compositions to mechanical components involving two or more contacting surfaces in relative motion.

### Description of the Related Art

Controlling friction and wear are of great importance for maintaining the integrity and extending the life mechanical components. In operation every mechanical component that experiences relative sliding and/or rolling contact under the influence of forces or stress experience friction and wear. The components of railways are particularly illustrative of such stresses. For example, the friction occurring at the contact interface between the steel wheel flanges and the rails of railway transport/locomotive vehicles determine and cause wear on wheel flange and gauge face of the rail. This wear process has a significant influence on the locomotive and rail track integrity, maintenance intervals, and overall service life of the wheel-rail system. This wear process is what results in noise emission and squealing sounds during operation that one with skill in the art would be able to readily identify. But more importantly excessive friction poses safety risks as it increases the risk of derailment. Therefore, reduction of friction can yield considerable energy/fuel savings and operational safety to the railway transport industry, including freight, passenger, and mass transit locomotive systems.

For wheel flange-rail lubrication, a solid monolithic stick lubricant is traditionally used by pressing it against the wheel flange by a spring mechanism. During contact, the stick transfers dry lubricant onto the wheel flange-rail contact interface. Majority of such monolithic sticks are related to solid lubricants comprising of a thermoplastic polymer carrier (such as polyester, low-density polyethylene, polypropylene, polyurethane, etc.), inorganic dry lubricant (such as graphite, molybdenum disulfide), oil (such as soybean oil, synthetic oil consisting of extreme pressure antiwear additives, etc.), and optionally polymeric plasticizer. Such stick compositions have been reported in U.S. Pat. Nos. 5,308,516; 5,173,204; 6,649,573; 2004/0043908; 4,915,856; 5,435,925; WO 90/15123; and EP 0372559, which are all herein incorporated by reference in their entirety. One of the biggest challenges of such solid monolithic sticks is variable consumption rate and transfer of solid lubricant with varying temperature and contact pressure. In addition, surface coverage is highly inconsistent due to the limited movement of dry solid phase lubricant at the friction zone under the influence of varying temperature and pressure. All these variations are undesirable for optimum control of friction and wear between wheel flange and rails.

Consequently, there is need for new stick lubricants that have a consistent consumption rate and can provide uniform coverage to a surface.

### SUMMARY

Provided herein are lubricating devices and methods for using them to provide uniform coverage of lubricating compositions to surfaces. In one specific embodiment, a lubricating device including: an encasing member, where the encasing member comprises a polymer composite, an outer surface, an inner surface, an inner space, an opening, a first end, and a second end, where the polymer composite has a hardness of about 20 to about 70 units in Shore D hardness scale; where the polymer composite includes less than 40 wt % of a polymer; and a lubricating composition, where the lubricating composition is disposed on the inner surface of the encasing member and/or positioned into the inner space of the encasing member.

In another specific embodiment, a method for lubricating a wheel flange-rail contact surfaces of a rail vehicle, the method includes: contacting a surface of a wheel flange of a rail vehicle with a lubricating device comprising: an encasing member, where the encasing member comprises a polymer composite, an outer surface, an inner surface, an inner space, an opening, a first end, and a second end, where the polymer composite has a hardness of about 20 to about 70 units in Shore D hardness scale; where the polymer composite includes less than 40 wt % of a polymer; and a lubricating composition, where the lubricating composition is disposed on the inner surface of the encasing member and/or positioned into the inner space of the encasing member; and depositing at least a portion of the lubricating composition on the surface of a wheel flange of a rail vehicle.

### BRIEF DESCRIPTION OF THE DRAWINGS

The present disclosure can be better understood by referring to the following drawings. The drawings constitute a part of this specification and include exemplary embodiments of the lubricating device, which may be embodied in various forms.

FIG. 1 shows the Stribeck curve illustrating the characteristics of the three lubrication regimes and the positive impact of the lubricating device on the friction and wear behavior at different lubrication regimes, as compared to traditional solid stick lubricants.

FIG. 2A shows an embodiment of the lubricating device in a cuboidal shape configuration with a full-length cylindrical-shaped core. FIG. 2B shows a cuboidal shaped portion of the encasing member of a polymer-based composite and the cylindrical shaped inner space filled with a semi-fluid grease-based composition.

FIG. 3A shows an embodiment of the lubricating device in cuboidal shape configuration with a full-length cuboidal-shaped inner space and/or core. FIG. 3B shows another an embodiment in cylindrical shape encasing member (circular cross-section) with a full-length cylindrical-shaped inner space and/or core. The lubricating device can include at-least one cylindrical or cuboidal shaped inner space and/or core running through the entire or partial length of the lubricating device.

FIGS. 4A-4C show a metallic mold that can be used to manufacture the encasing member of an embodiment of a lubricating device. It also shows the as-manufactured cuboidal stick with polymer-based composition and its internal cylindrical-shaped inner space filled with semi-fluid grease-based lubricant.

### DETAILED DESCRIPTION

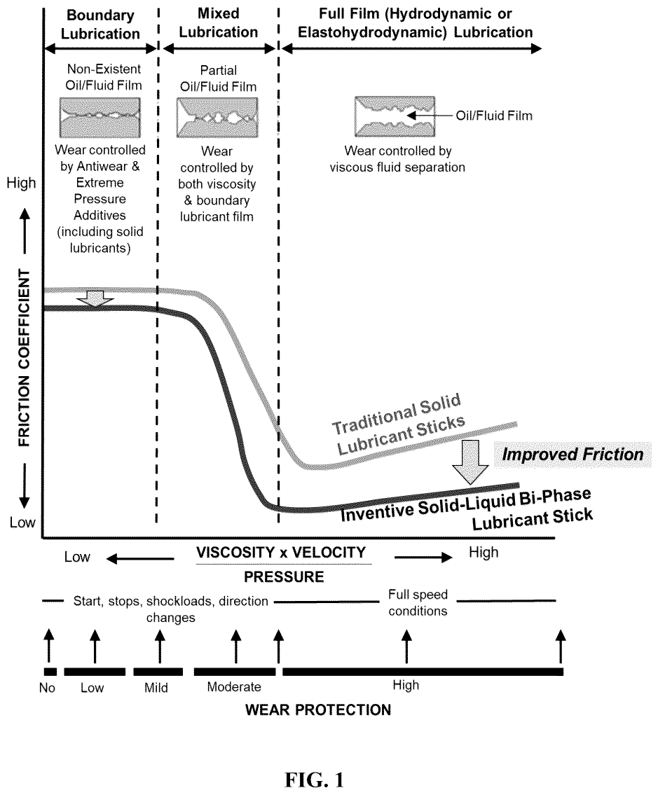

The lubricating device can include a polymer-based composite enriched with solid lubricants and other performance additives. However, as opposed to traditional monolithic sticks, the lubricating device can include one or more inner spaces and/or hollow cores that are filled with a semi-fluid grease-based lubricant. The lubricating device with grease filled inner space can facilitate the simultaneous solid and liquid phase lubrication to favor advanced tribological performance in all known lubrication regimes, including hydrodynamic, mixed, and boundary lubrication regimes as demonstrated in the Stribeck curve of FIG. 1.

As shown in FIG. 1, there are four lubrication regimes as determined by the operational speeds, loading experienced by the contact surfaces and viscosity of the lubricant. At low speeds (e.g., initial start-up or shutdown) or under heavy loading, boundary lubrication is prevalent. In this regime, if lubricant film is not thick enough (low viscosity), severe metal-to-metal asperity contact may occur. In this lubrication regime, presence of antiwear and extreme pressure additives (including solid lubricants) capable of forming thin surface films are very important for wear protection. In general, boundary lubrication shall be avoided where possible. As speed increases (transition from low to high speed operation), asperity contact reduces and oil/fluid lubricant film thickness increases leading to dramatic drop in friction coefficient. This regime is known as mixed lubrication as some metal-to-metal asperity loading still exists. At high operational speeds, hydrodynamic or full film lubrication is prevalent where the load carrying surfaces are separated by a thick oil/fluid lubricant film. Therefore, considering the characteristics of lubrication regimes, correct lubricant viscosity is a critical factor for optimum performance. A lubricant with too low viscosity cannot prevent metal-to-metal contact in boundary and mixed lubrication regimes. A lubricant with too high viscosity will result in an increase in the lubricant's molecular friction and loss of efficiency, especially in hydrodynamic regime. Although lubricant viscosity is directly influenced by temperature, chemical composition also plays a key role. Therefore, the lubricating device has been provided with solid-liquid bi-phase lubricating composition to have optimum viscosity (neither too low nor too high) as opposed to dominance of high viscosity in traditional solid stick lubricants due to entirely solid composition. As compared to traditional solid stick lubricants, the lubricating device can provide better flowability due to greater molecular mobility in liquid as compared to solids. These characteristics will enable the lubricating device to have improved control on friction and wear protection of mechanical systems including rail-wheel flange tribosystem.

In one or more embodiments, the lubricating devices can include, but are not limited to: one or more encasing members and one or more lubricating compositions. The lubricating device can be used for applying lubricating compositions to mechanical components and contact surfaces for controlling friction and wear when such surfaces are in relative motion with a force pushing them together.

The dimensional configuration of the inner core and/or inner space in relation to the encasing members can optimally transfer of liquid-phase grease without leakage from lubricating device and overspreading at the rail-wheel flange contact interface. Furthermore, the lubricating device can provide optimal consumption rate, lubricant transfer, and tribochemistry of lubricant transfer films for optimum control of interfacial friction and wear.

The one or more encasing members can include, but are not limited to: one or more lengths, one or more heights, one or more widths, one or more radii, one or more ends, a front side, a back side, a right side, a left side, a top side, a bottom side, one or more openings, one or more outer surfaces, one or more inner surfaces, and one or more inner spaces. The one or more encasing members can include a shape that varies widely. For example, the shape of the encasing member can include, but is not limited to: parallelepiped, rhombohedron, cuboid, polyhedron, prism, cone, cylinder, ellipsoid, lemon, hyperboloid. In another example, the encasing member can include, but is not limited to: a cylindrical shape, a stick shape, and an oblate spheroid shape. In another example, the encasing members can include a cylindrical shape with a first end, a second end, a radius, and a length. In yet another example, the encasing member can include a cylindrical shape with a first open end and a second open end. The one or more encasing members can include a solid phase.

The one or more encasing members can include a length that varies widely. For example, the encasing members can include a length from a short of about 0.5 cm, about 1.0 cm, or about 2.0 cm, to a long of about 50.0 cm, about 55.0 cm, or about 60.0 cm. In another example, the encasing members can include a length from about 0.5 cm to about 60.0 cm, about 1.0 cm to about 20.0 cm, about 2.0 cm to about 38.0 cm, about 2.5 cm to about 25.0 cm, about 5.0 cm to about 30.0 cm, about 7.0 cm to about 40.0 cm, about 8.0 cm to about 30.0 cm, about 12.0 cm to about 55.0 cm, about 15.0 cm to about 48.0 cm, or about 20.0 cm to about 58.0 cm.

The one or more encasing members can include a width that varies widely. For example, the encasing members can include a width from a short of about 0.5 cm, about 1.0 cm, or about 2.0 cm, to a long of about 50.0 cm, about 55.0 cm, or about 60.0 cm. In another example, the encasing members can include a width from about 0.5 cm to about 60.0 cm, about 1.0 cm to about 20.0 cm, about 2.0 cm to about 38.0 cm, about 2.5 cm to about 25.0 cm, about 5.0 cm to about 30.0 cm, about 7.0 cm to about 40.0 cm, about 8.0 cm to about 30.0 cm, about 12.0 cm to about 55.0 cm, about 15.0 cm to about 48.0 cm, or about 20.0 cm to about 58.0 cm.

The one or more encasing members can include a height that varies widely. For example, the encasing members can include a height from a short of about 0.5 cm, about 1.0 cm, or about 2.0 cm, to a long of about 50.0 cm, about 55.0 cm, or about 60.0 cm. In another example, the encasing members can include a height from about 0.5 cm to about 60.0 cm, about 1.0 cm to about 20.0 cm, about 2.0 cm to about 38.0 cm, about 2.5 cm to about 25.0 cm, about 5.0 cm to about 30.0 cm, about 7.0 cm to about 40.0 cm, about 8.0 cm to about 30.0 cm, about 12.0 cm to about 55.0 cm, about 15.0 cm to about 48.0 cm, or about 20.0 cm to about 58.0 cm.

The one or more encasing members can include a radius that varies widely. For example, the encasing members can include a radius from a short of about 0.5 cm, about 1.0 cm, or about 2.0 cm, to a long of about 50.0 cm, about 55.0 cm, or about 60.0 cm. In another example, the encasing members can include a radius from about 0.5 cm to about 60.0 cm, about 1.0 cm to about 20.0 cm, about 2.0 cm to about 38.0 cm, about 2.5 cm to about 25.0 cm, about 5.0 cm to about 30.0 cm, about 7.0 cm to about 40.0 cm, about 8.0 cm to about 30.0 cm, about 12.0 cm to about 55.0 cm, about 15.0 cm to about 48.0 cm, or about 20.0 cm to about 58.0 cm.

The one or more encasing members can include, but is not limited to: one or more inner spaces and/or cores. The one or more inner spaces can include, but is not limited to: one inner space, two inner spaces, three inner spaces, four inner spaces, five inner spaces, and more inner spaces. The one or more inner spaces and/or cores can include one or more inner surfaces. The one or more inner spaces can include one or more lengths, one or more heights, one or more widths, one or more radii, one or more ends, front side, back side, right side, left side, top side, bottom side, and one or more outer inner surfaces. The shape of the inner component can include, but is not limited to: parallelepiped, rhombohedron, cuboid, polyhedron, prism, cone, cylinder, ellipsoid, lemon, hyperboloid. For example, the inner spaces can include, but is not limited to: a cylindrical shape, a stick shape, and an oblate spheroid shape. In another example, the inner component can include a cylindrical shape with a radius and a length. In another example, the one or more internal spaces can include a hollow core that spans at least a portion of the length of the one or more encasing members. In another example, the inner spaces can be at least partially positioned lengthwise along the encasing member. In another example, the inner spaces can be at least partially positioned widthwise along the encasing member. In yet another example, the inner spaces can be at least partially positioned height-wise along the encasing member.

The one or more inner spaces can include a length that varies widely. For example, the inner spaces can include a length from a short of about 0.1 cm, about 1.0 cm, or about 2.0 cm, to a long of about 50.0 cm, about 55.0 cm, or about 60.0 cm. In another example, the inner spaces can include a length from about 0.1 cm to about 60.0 cm, about 1.0 cm to about 20.0 cm, about 2.0 cm to about 38.0 cm, about 2.5 cm to about 25.0 cm, about 5.0 cm to about 30.0 cm, about 7.0 cm to about 40.0 cm, about 8.0 cm to about 30.0 cm, about 12.0 cm to about 55.0 cm, about 15.0 cm to about 48.0 cm, or about 20.0 cm to about 58.0 cm.

The one or more inner spaces can include a width that varies widely. For example, the inner spaces can include a width from a short of about 0.1 cm, about 1.0 cm, or about 2.0 cm, to a long of about 50.0 cm, about 55.0 cm, or about 60.0 cm. In another example, the inner spaces can include a width from about 0.1 cm to about 60.0 cm, about 1.0 cm to about 20.0 cm, about 2.0 cm to about 38.0 cm, about 2.5 cm to about 25.0 cm, about 5.0 cm to about 30.0 cm, about 7.0 cm to about 40.0 cm, about 8.0 cm to about 30.0 cm, about 12.0 cm to about 55.0 cm, about 15.0 cm to about 48.0 cm, or about 20.0 cm to about 58.0 cm.

The one or more inner spaces can include a height that varies widely. For example, the inner spaces can include a height from a short of about 0.1 cm, about 1.0 cm, or about 2.0 cm, to a long of about 50.0 cm, about 55.0 cm, or about 60.0 cm. In another example, the inner spaces can include a height from about 0. cm to about 60.0 cm, about 1.0 cm to about 20.0 cm, about 2.0 cm to about 38.0 cm, about 2.5 cm to about 25.0 cm, about 5.0 cm to about 30.0 cm, about 7.0 cm to about 40.0 cm, about 8.0 cm to about 30.0 cm, about 12 cm to about 55.0 cm, about 15.0 cm to about 48.0 cm, or about 20.0 cm to about 58.0 cm.

The one or more inner spaces can include a radius that varies widely. For example, the encasing members can include a radius from a short of about 0.1 cm, about 1.0 cm, or about 2.0 cm, to a long of about 50.0 cm, about 55.0 cm, or about 60.0 cm. In another example, the inner spaces can include a radius from about 0.1 cm to about 60.0 cm, about 1.0 cm to about 20.0 cm, about 2.0 cm to about 38.0 cm, about 2.5 cm to about 25.0 cm, about 5.0 cm to about 30.0 cm, about 7.0 cm to about 40.0 cm, about 8.0 cm to about 30.0 cm, about 12.0 cm to about 55.0 cm, about 15.0 cm to about 48.0 cm, or about 20.0 cm to about 58.0 cm.

The one or more openings can include, but are not limited to, a first opening, second opening, third opening, forth opening, fifth opening, and more openings. In an embodiment, the openings can be disposed on the one or more outer surfaces. In an embodiment, the openings can provide an opening for and access to the one or more inner spaces and/or the one or more inner surfaces.

The one or more encasing members can include, but are not limited to: one or more waxes, one or more normal alpha olefins (NAOs), one or more fatty acids, one or more polymers, one or more plasticizers, one or more corrosion inhibitors, one or more catalysts, one or more fillers, one or more curing agents, and one or more additives.

The one or more waxes can include, but are not limited to: microcrystalline wax, soy wax, paraffin wax, polyethylene wax, and mixtures thereof. The encasing member can have weight percent of the one or more waxes that varies widely. For example, the encasing members can have weight percent of the waxes from a low of about 0.1 wt %, about 1.0 wt %, or about 5.0 wt %, to a high of about 80.0 wt %, about 90.0 wt %, or about 100.0 wt %. For example, the encasing members can have weight percent of the waxes from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the encasing member can be free of the one or more waxes. The weight percent of the one or more waxes in the encasing member can be based on the weight of the total composition, or based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives.

The one or more normal alpha olefins (NAOs) can include, but are not limited to: 1-butene, 1-hexene, 1-octene, 1-decene, 1-dodecene, 1-tetradecene, 1-hexadecene, 1-octadecene, C₂₀-C₂₄ olefin blends, C₂₄-C₃₀ olefin blends, C₂₀-C₃₀ olefin blends, and mixtures thereof. The encasing member can have weight percent of the one or more normal alpha olefins that varies widely. For example, the encasing members can have weight percent of normal alpha olefins from a low of about 0.1 wt %, about 1.0 wt %, or about 5.0 wt %, to a high of about 80.0 wt %, about 90.0 wt %, or about 100.0 wt %. For example, the encasing members can have weight percent of normal alpha olefins from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the encasing member can be free of the one or more normal alpha olefins. The weight percent of the one or more normal alpha olefins in the encasing member can be based on the weight of the total composition, or based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives.

The one or more fatty acids can include, but are not limited to: stearic acids, palmitic acid, myristic acid, lauric acid, linoleic acid, oleic acid, arachidonic acid, nonadecylic acid, margaric acid, and mixtures thereof. The encasing member can have weight percent of the one or more fatty acids that varies widely. For example, the encasing members can have weight percent of fatty acids from a low of about 0.1 wt %, about 1.0 wt %, or about 5.0 wt %, to a high of about 80.0 wt %, about 90.0 wt %, or about 100.0 wt %. For example, the encasing members can have weight percent of fatty acids from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the encasing member can be free of the one or more fatty acids. The weight percent of the one or more fatty acids in the encasing member can be based on the weight of the total composition, or based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives.

The one or more polymers can include, but are not limited to: epoxy, melamine formaldehyde, polyester, unsaturated polyester styrene, urea formaldehyde, polyurethane, phenol formaldehyde, polyamide, polymethyl methacrylate, polyvinyl chloride, polypropylene, polystyrene, low-density polyethylene, high-density polyethylene, and mixtures thereof. The one or more polymers can include one or more thermoplastic polymers, one or more thermosetting polymers, and mixtures thereof.

The one or more thermoplastic polymers can include, but are not limited to: polypropylene, polystyrene, high-density polyethylene (HDPE), low-density polyethylene (LDPE), polylactide (PLA), polyvinyl chloride (PVC), polybutylene succinate (PBS), polyamides, acrylonitrile butadiene styrene (ABS), soy wax, paraffin wax, polyethylene wax, and mixtures thereof. The one or more thermosetting polymers can include, but are not limited to: polyesters, vinyl esters, epoxy, polyurethane, polysiloxanes, and mixtures thereof.

The encasing member can have weight percent of the one or more polymers that varies widely. For example, the encasing members can have weight percent of the polymers from a low of about 0.1 wt %, about 1.0 wt %, or about 5.0 wt %, to a high of about 80.0 wt %, about 90.0 wt %, or about 100.0 wt %. For example, the encasing members can have weight percent of the polymers from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the encasing member can be free of the one or more polymers. The weight percent of the one or more polymers in the encasing member can be based on the weight of the total composition, or based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives.

The one or more catalysts and the one or more curing agents can include, but are not limited to: methyl ethyl ketone peroxide (MEKP), MEKP DDM-9 catalyst dibasic acid polyester diethylene triamine (DETA), aminoethyl piperazine (AEP), meta-phenylenediamine (MPDA), methylenedianiline (MDA), nadic methyl anhydride (NMA), phthalic anhydride (PA), and metallic driers based on cobalt, zirconium, manganese, and calcium. The one or more catalysts and the one or more curing agents can include commercially available catalysts and curing agents. The selection of catalysts and curing agents can depend on the type of polymer used to make the encasing member.

The encasing member can have weight percent of the one or more catalysts that varies widely. For example, the encasing members can have weight percent of catalysts from a low of about 0.001 wt %, about 0.01 wt %, or about 0.1 wt %, to a high of about 5.0 wt %, about 90.0 wt %, or about 100.0 wt %. For example, the encasing members can have weight percent of the catalysts from about 0.001 wt % to about 100.0 wt %, about 0.001 wt % to about 2.0 wt %, about 0.01 wt % to about 2.0 wt %, about 0.1 wt % to about 2.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the encasing member can be free of the one or more catalysts. The weight percent of the one or more catalysts in the encasing member can be based on the weight of the total composition, or based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives.

The encasing member can have weight percent of the one or more curing agents that varies widely. For example, the encasing members can have weight percent of curing agents from a low of about 0.1 wt %, about 1.0 wt %, or about 5.0 wt %, to a high of about 80.0 wt %, about 90.0 wt %, or about 100.0 wt %. For example, the encasing members can have weight percent of the curing agents from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the encasing member can be free of the one or more curing agents. The weight percent of the one or more curing agents in the encasing member can be based on the weight of the total composition, or based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives.

The one or more filler materials can include, but are not limited to: saw dust, wood flour filler, calcium carbonate, calcium fluoride, carbon black, titanium dioxide, barium sulfate, mica, silicates, halloysite, carbon fibers, graphene, graphite flakes, carbon black, glass fibers, and mixtures thereof. The one or more filler materials can mechanically strengthen and aesthetically modified the lubricating device.

The encasing member can have weight percent of the one or more fillers that varies widely. For example, the encasing members can have weight percent of filler from a low of about 0.1 wt %, about 1.0 wt %, or about 5.0 wt %, to a high of about 80.0 wt %, about 90.0 wt %, or about 100.0 wt %. For example, the encasing members can have weight percent of the filler from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the encasing member can be free of the one or more fillers. The weight percent of the one or more fillers in the encasing member can be based on the weight of the total composition, or based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives.

In an embodiment, the lubricating device can include: about 2.0 wt % to about 40.0 wt % of microcrystalline wax, normal alpha olefins, and/or stearic acid; about 0.0 wt % to about 40.0 wt % of a thermoplastic or thermosetting polymer; about 0.0 wt % to about 50.0 wt % of inorganic solid lubricants; about 0.0 wt % to about 20.0 wt % of filler; about 0.0 wt % to about 10.0 wt % of additives in the lubricating composition; about 0.0 wt % to about 20.0 wt % of plasticizers; about 0.0 wt % to about 5.0 wt % of corrosion inhibitors; and about 0.0 wt % to about 20.0 wt % of hardener and/or curing catalysts. The weight percent can be based on the weight of the total composition, or based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives.

The one or more lubricating compositions can include, but are not limited to: one or more greases, one or more inorganic solid lubricants, one or more polymers, one or more additives, and mixtures thereof. In an embodiment, the lubricating composition can be placed into the inner space of the encasing member. In another embodiment, the lubricating composition can be filled into the inner space and/or inner surface of the encasing member. In another embodiment, the lubricating composition can be at least partially disposed onto the inner surface of the encasing member. In another embodiment, the lubricating composition can be at least partially positioned in the inner space of the encasing member. In yet another embodiment, the lubricating composition can fill the inner space of the encasing member.

The one or more greases can include, but are not limited to: lithium based, lithium-complex, aluminum-complex, calcium-sulfonate complex, bentone-thickened grease, mineral oil, petroleum-based oil, synthetic oil, and a mixture thereof. The greases can include commercially available greases. The lubricating compositions can include oil with a NLGI (National Lubricating Grease Institute) consistency grade of greater than or equal to 1. Table 1 lists the relation between grease consistency and NLGI grade. The lubricating compositions can include synthetic oils having low pour point and high viscosity index that can be selected for optimum performance of the lubricating device in all seasons from extreme hot weather to sub-zero temperatures without any loss of performance.

The one or more inorganic solid lubricants can include, but are not limited to: one or more 2D structured solid lubricant materials, one or more 3D structured solid lubricant materials, and mixtures thereof. The 2D inorganic solid lubricants can include, but are not limited to: graphene platelets, graphene oxides, 2D-hBN, MXenes, and mixtures thereof. The 3D inorganic solid lubricants can include, but are not limited to: natural graphite, synthetic graphite, molybdenum disulfide, tungsten disulfide, hexagonal boron nitride, polytetrafluoroethylene (PTFE) particles, and mixtures thereof. The modification of the one or more lubricating composition with inorganic solid lubricants can enhance the antifriction and antiwear tribochemical properties of the lubricating composition. Furthermore, such mixture also assists in modifying the rheological property of the semi-fluid grease for optimum retention and flow/transfer from the core of the lubricating device.

The lubricating compositions can have weight percent of the one or more greases that varies widely. For example, the lubricating compositions can have weight percent of the grease from a low of about 0.1 wt %, about 1.0 wt %, or about 5.0 wt %, to a high of about 80.0 wt %, about 90.0 wt %, or about 100.0 wt %. For example, the lubricating compositions can have weight percent of the grease from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, lubricating compositions can be free of the one or more greases. The weight percent of the one or more greases lubricating compositions can be based on the weight of the total composition, or based on the total weight of the one or more greases, one or more inorganic solid lubricants, one or more polymers, one or more additives.

The lubricating composition can have weight percent of the one or more inorganic solid lubricants that varies widely. For example, the lubricating composition can have weight percent of the inorganic solid lubricants from a low of about 0.1 wt %, about 1.0 wt %, or about 5.0 wt %, to a high of about 80.0 wt %, about 90.0 wt %, or about 100.0 wt %. For example, the lubricating compositions can have weight percent of the inorganic solid lubricants from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, lubricating compositions can be free of the one or more inorganic solid lubricants. The weight percent of the one or more inorganic solid lubricants can be based on the weight of the total composition, or based on the total weight of the one or more greases, one or more inorganic solid lubricants, one or more polymers, one or more additives.

The one or more additives for the both the encasing member and the lubricating composition can include, but are not limited to: one or more friction modifiers, one or more plasticizer, one or more corrosion inhibitors, one or more antiwear, one or more extreme pressure additives, zinc dithiophosphate (ZDDP), one or more organomolybdenum compounds, one or more organoboron compounds, one or more organophosphorus compounds, one or more organosulfur compound, one or more inorganic solid lubricants, one or more 2D inorganic solid lubricants, one or more 3D inorganic solid lubricant, and mixtures thereof. The one or more additives can be added to the compositions for both the encasing member and to the lubricating composition to enhance the tribochemical properties of the lubricating device.

The one or more organomolybdenum compounds can include, but are not limited to: molybdenum dithiocarbamates (MoDTC), molybdenum dithiophosphate (MoDTP), molybdenum dialkyldithiophosphate (MoDDP), and mixtures thereof.

The one or more organoboron compounds can include, but are not limited to: trimethoxyboroxine; 2-methoxy-4,4,6-trimethyl-1,3,2-dioxaborinane; 2-ethoxy-4,4,6-trimethyl-1,3,2-dioxaborinane; trimethyl borate; and mixtures thereof.

The one or more organophosphorus compounds can include, but are not limited to: bis(2-ethylhexyl) phosphate; trioleyl phosphite; trilauryl trithio phosphite; dilauryl hydrogen phosphite; diphenyl hydrogen phosphite; ethyl acid phosphate; butyl acid phosphate; 2-ethylhexyl acid phosphate, dibutyl phosphite; dioleyl hydrogen phosphite; butoxyethyl acid phosphate; ethylene glycol acid phosphate; dibutyl phosphate; and mixtures thereof.

The one or more organosulfur compound can include, but are not limited to: methylenebis(dibutyldithiocarbamate), while heterocyclic compounds can be selected from benzotriazoles and 1,3,4-thiadiazoles group.

The encasing member and the lubricating composition can include an inorganic solid lubricant which may consist of one or more combination of at-least one 2D structured and one 3D structured solid lubricant material. 2D inorganic solid lubricants can include graphene platelets, graphene oxide, 2D-hBN, and/or MXenes, and 3D inorganic solid lubricants may be selected from natural graphite, synthetic graphite, molybdenum disulfide, tungsten disulfide, hexagonal boron nitride, and polytetrafluoroethylene (PTFE) particles. The lubricating properties of such materials are well known to those skilled in the art.

Like the polymer-based compositions for the encasing member, the lubricating composition can include one or more 2D and one or more 3D inorganic solid lubricant. The modification of polymer-based composition and lubricating compositions with inorganic solid lubricants can enhance the antifriction and antiwear tribochemical properties of the lubricating device. Moreover, such mixtures can also assist in modifying the rheological property of the semi-fluid grease for optimum retention and flow/transfer from the core of the lubricating device.

The one or more encasing members can have weight percent of the one or more additives that varies widely. For example, the encasing members can have weight percent of the additives from a low of about 0.1 wt %, about 1.0 wt %, or about 5.0 wt %, to a high of about 80.0 wt %, about 90.0 wt %, or about 100.0 wt %. For example, the encasing members can have weight percent of the additives can have weight percent of the one or more normal alpha olefins from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the one or more encasing members can be free of the one or more additives. In an embodiment, lubricating compositions can be free of the one or more inorganic solid lubricants. The weight percent of the one or more inorganic solid lubricants can be based on the weight of the total composition, or based on the total weight of the one or more greases, one or more inorganic solid lubricants, one or more polymers, one or more additives.

The lubricating compositions can have weight percent of the one or more additives that varies widely. For example, the lubricating compositions can have weight percent of the additives from a low of about 0.1 wt %, about 1.0 wt %, or about 5.0 wt %, to a high of about 80.0 wt %, about 90.0 wt %, or about 100.0 wt %. For example, the lubricating compositions can have weight percent of the additives from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the lubricating compositions can be free of the one or more additives.

The one or more plasticizers can include, but are not limited to: one or more phthalates, one or more phthalate esters, one or more sebacates, one or more adipates, one or more terephthalates, one or more benzoates one or more, one or more glutarates, one or more azelates, one or more epichlorohydrin, one or more ethylene propylene diene monomer rubber, one or more polyols, one or more organic esters, one or more bio-based oils, one or more glycerides, and mixtures thereof. The one or more polyos can include, but are not limited to: glycerin, propylene glycol, polyethylene glycol (PEG). The one or more organic esters can include, but are not limited to: phthalate esters, aliphatic dibasic acid esters, benzoate esters, dibutyl sebacate, citrate esters, and triacetin. The one or more bio-based oils/glycerides can include, but are not limited to: castor oil, palm oil, acetylated monoglycerides, fractionated coconut oil, epoxidized linseed oil, and epoxidized soybean oil. The plasticizers can include commercially available plasticizers. The one or more plasticizers can increase the flow, flexibility, and thermoplasticity of the compositions. The one or more plasticizers can include commercially available plasticizers. For example, a suitable commercially available plasticizer can include PALAMOLL® 652 by BASF.

The encasing member and/or the lubricating composition can have weight percent of the one or more plasticizers that varies widely. For example, the encasing members can have weight percent of the plasticizers from a low of about 0.1 wt %, about 1.0 wt %, or about 5.0 wt %, to a high of about 80.0 wt %, about 90.0 wt %, or about 100.0 wt %. For example, the encasing members can have weight percent of the plasticizers from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the encasing member and/or the lubrication composition can be free of the one or more plasticizers. The weight percent of the one or more plasticizers in the encasing member can be based on the weight of the total composition; based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives; or based on the total weight of the one or more greases, one or more inorganic solid lubricants, one or more polymers, one or more additives.

The one or more corrosion inhibitors can include, but are not limited to: one or more organic inhibitors, one or more anodic inhibitors, and mixtures thereof. The one or more anodic inhibitors can include, but are not limited to: chromates, nitrates, molybdates, tungstate, mixtures thereof. Mixed inhibitors, particularly film-forming compounds that reduce both anodic and cathodic corrosion reactions can also be used, including but not limited to silicates and phosphates.

The one or more encasing members and/or the one or more lubricating compositions can have weight percent of the one or more corrosion inhibitors that varies widely. For example, the encasing members and the compositions can have weight percent of the corrosion inhibitors from a low of about 0.1 wt %, about 1.0 wt %, or about 5.0 wt %, to a high of about 80.0 wt %, about 90.0 wt %, or about 100.0 wt %. For example, the encasing members can have weight percent of the corrosion inhibitors from about 0.1 wt % to about 100.0 wt %, about 0.1 wt % to about 99.9 wt %, about 0.1 wt % to about 10.0 wt %, about 1.0 wt % to about 12.0 wt %, about 0.1 wt % to about 20.0 wt %, about 2.0 wt % to about 20.0 wt %, about 10.0 wt % to about 20.0 wt %, about 20.0 wt % to about 30.0 wt %, about 30.0 wt % to about 50.0 wt %, about 40.0 wt % to about 60.0 wt %, about 75.0 wt % to about 95.0 wt %, about 80.0 wt % to about 99.9 wt %, about 85.0 wt % to about 95.0 wt %, about 90.0 wt % to about 99.9 wt %, or about 92.0 wt % to about 98.0 wt %. In another example, the encasing member and/or lubricating composition can be free of the one or more corrosion inhibitors. The weight percent of the one or more corrosion inhibitors in the encasing member can be based on the weight of the total composition; based on the total weight of the one or more waxes, one or more normal alpha olefins, one or more fatty acids, one or more polymers, one or more plasticizers, one or more corrosion inhibitors, one or more catalysts, one or more fillers, one or more curing agents, and one or more additives; or based on the total weight of the one or more greases, one or more inorganic solid lubricants, one or more polymers, one or more additives.

The inorganic solid lubricant can include a particle size that can vary widely. For example, the inorganic solid lubricant can have a particle size from a small of about 1 nm, about 50 nm, or about 100 nm, to a large of about 50 microns, about 100 microns, or about 300 microns. In another example, the inorganic solid lubricant can have a particle size from about 1 nm to about 300 microns, about 10 nm to about 50 nm, about 50 nm to about 100 nm, about 100 nm to about 500 nm, about 650 nm to about 1 micron, about 2 microns to about 10 microns, about 5 microns to about 50 microns, about 50 microns to about 100 microns, about 75 microns to about 250 microns, or about 200 microns to about 300 microns.

In an embodiment, the lubricating composition can include from about 80.0 wt % to about 100.0 wt % of grease, about 0.0 wt % to about 10.0 wt % of inorganic solid lubricants, and about 0.0 wt % to about 10.0 wt % of additives.

The one or more lubricating compositions can include a National Lubricating Grease Institute (NLGI) consistency number or grade that varies widely. For example, the lubricating composition can have an NLGI number or grade of 000, 00, 0, 1, 2, 3, 4, 5, or 6. In another example, the lubricating composition with consistency of greater or equal to NLGI 1. In another example, the lubricating composition can have an ASTM worked (60 strokes) penetration at 25° C. in tenths of a millimeter from about 445 to about 475, about 400 to about 430, about 355 to about 385, about 310 to about 340, about 265 to about 295, about 220 to about 250, about 175 to about 205, about 130 to about 160, or about 85 to about 115.

The hardness of the encasing member of the lubricating device can vary widely. For example, the encasing member can have a Shore D hardness from a low of about 15 units, about 20 units, or about 25 units, to a high of about 65 units, about 70 units, or about 75 units. In another example, the encasing member can have a Shore D hardness from about 15 units to about 75 units, about 16 units to about 35 units, about 20 units to about 50 units, about 21 units to about 67 units, about 24 units to about 55 units, or about 23 units to about 72 units. The Shore D hardness can depend on the type and concentration of the ingredients used for preparation of the solid polymer-based composite.

The lubricating composition can include a base oil viscosity that varies widely. For example, the lubricating composition can include base oil viscosity from a low of about 10 centistokes (cSt), about 20 cSt, or about 30 cSt, about 200 cSt, about 400 cSt, or about 900 cSt. In another example, the lubricating composition can include base oil viscosity from about 10 cSt to about 900 cSt, about 20 cSt to about 225 cSt, or about 30 cSt to about 250 cSt. The base oil viscosity of the lubricating composition can be measured according to ASTM D445, cSt @40° C.

The lubricating composition can include a worked penetration measured according to ASTM D-217 (60 strokes @25° C.) that varies widely. For example, lubricating composition can include a worked penetration measured in 1/10 mm penetration units from about 100, about 200, about 250, to a high of about 350, about 400, about 700. In another example, lubricating composition can include a worked penetration measured in 1/10 mm penetration units from about 100 to about 700, about 200 to about 300, about 250 to about 350, or about 295 to about 310.

The lubricating composition can include a dropping point measured according to ASTM D-2265 that varies widely. For example, lubricating composition can include a dropping point from a low of about 100° C., about 200° C., about 250° C., to a high of about 450° C., about 700° C., about 900° C. In another example, lubricating composition can include a dropping point from about 100° C. to about 900° C., about 200° C. to about 500° C., about 250° C. to about 700° C., about 300° C. to about 500° C. In another example, lubricating composition can include dropping point of greater than 260° C.

The lubricating composition can include a four-ball wear measured according to ASTM D-2266 that varies widely. For example, lubricating composition can include a four-ball wear from a low of about 0.1 mm, about 0.2 mm, or about 0.5 mm, to a high of about 0.7 mm, about 0.9 mm, or about 1.0 mm. In another example, lubricating composition can include a four-ball wear from about 0.1 mm to about 0.9 mm, about 0.2 mm to about 0.5 mm, about 0.2 mm to about 0.6 mm, or about 0.3 mm to about 0.7 mm.

The lubricating composition can include a four-ball extreme pressure, weld load measured according to ASTM D-2596 that varies widely. For example, lubricating composition can include a four-ball extreme pressure, weld load from a low of about 100 kg, about 200 kg, or about 300 kg, to a high of about 400 kg, about 500 kg, or about 800 kg. In another example, lubricating composition can include a four-ball extreme pressure, weld load from about 100 kg to about 700 kg, about 200 kg to about 600 kg, about 300 kg to about 500 kg, or about 400 kg to about 600 kg.

In one or more embodiments, the methods for using the lubricating device can include, but are not limited to: contacting the lubricating device to surfaces of mechanical components to apply at least a portion of the lubricating composition to the surface. The surfaces of mechanical components can include two or more contacting surfaces in relative motion. For example, the method of using the lubricating device can include contacting lubricating composition of the lubricating device to a wheel flange-rail contact surfaces for controlling deleterious effects of friction and wear in railway transport/locomotive vehicles. By contacting the lubricating device onto the wheel and/or rail surface, the lubricating device also provides a method of controlling the lateral forces between the railway vehicle and the track, maintenance of adequate positive friction, and as well as reduced emission of squealing sounds/noise. The unique design of the stick complemented by its chemical composition facilities the tribological benefits of both solid and liquid phase lubrication for superior and long-lasting performance of wheel-rail mechanical system along with energy savings.

The lubricating devices can provide a method of solid-liquid bi-phase lubrication of mechanical components involving two or more contacting surfaces in relative motion (sliding and/or rolling). By contacting the lubricating device to surfaces, the solid-phase lubricant (from the cuboidal stick with polymer-based composition) and liquid-phase lubricant (from the core filled with grease-based composition) are transferred onto the contact zone for consistent lubrication. Such bi-phase lubricating device can perform in all lubrication regimes to alleviate deleterious effects of friction and wear for smooth and lasting performance of the mechanical system.

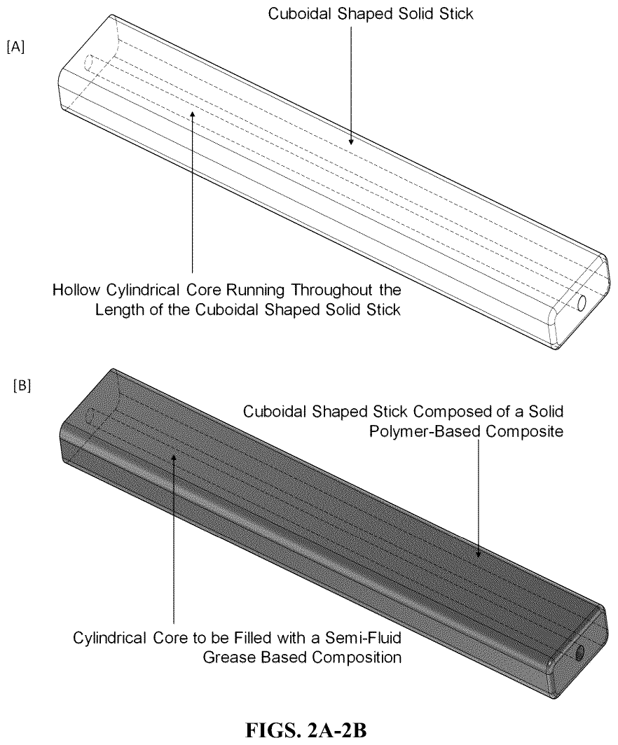

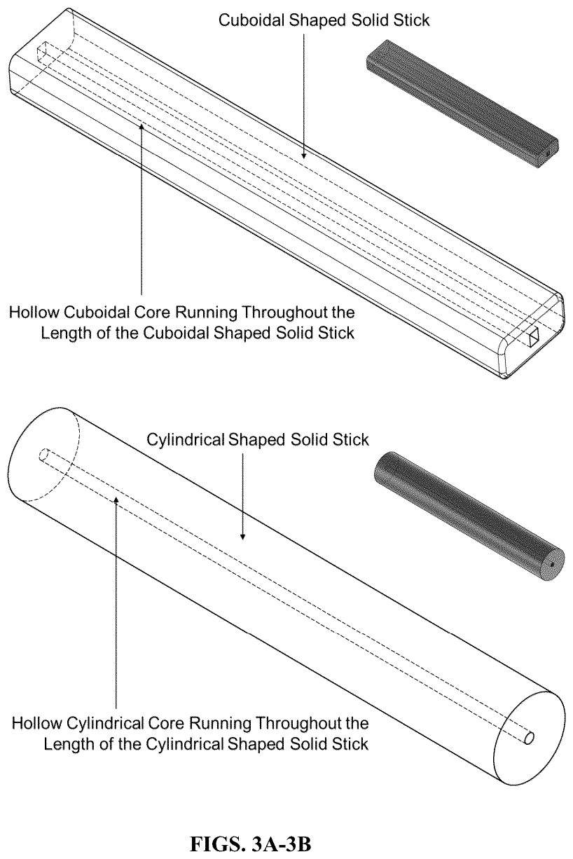

In an embodiment, the lubricating devices can include a cuboidal shaped stick with at-least one cylindrical or cuboidal shaped hollow core and/or inner space running through entire or partial length of the stick. FIG. 2 shows an embodiment of the lubricating stick in a cuboidal shape configuration with a full-length cylindrical core and/or inner space. FIG. 3 shows another embodiment of the lubricating devices in cuboidal shape configuration with a full-length cuboidal-shaped core and/or inner space. The cuboidal shaped solid lubricating devices can include a solid polymer-based composite while the hollow cylindrical/cuboidal shaped core can be filled with a semi-fluid grease lubricant. In another embodiment, the lubricating devices can also be formed in cylindrical shape (circular cross-section).

The dimensional configuration of the lubricating device can provide for easy loading into traditional applicators that are used to apply the lubricating device onto a steel/contact surface. The applicators can consist of a spring-loaded mechanism that continuously presses the lubricating device against the target surface. Example of such applicators that can be used with the lubricating device are disclosed in U.S. Pat. Nos. 4,811,818; 5,054,582; 5,251,724; 5,337,860; 2003/0101897; and 7,709,426B2, which are all herein incorporated by reference in their entirety.

### Examples

To provide a better understanding of the foregoing discussion, the following non-limiting examples are offered. Although the examples can be directed to specific embodiments, they are not to be viewed as limiting the invention in any specific respect.

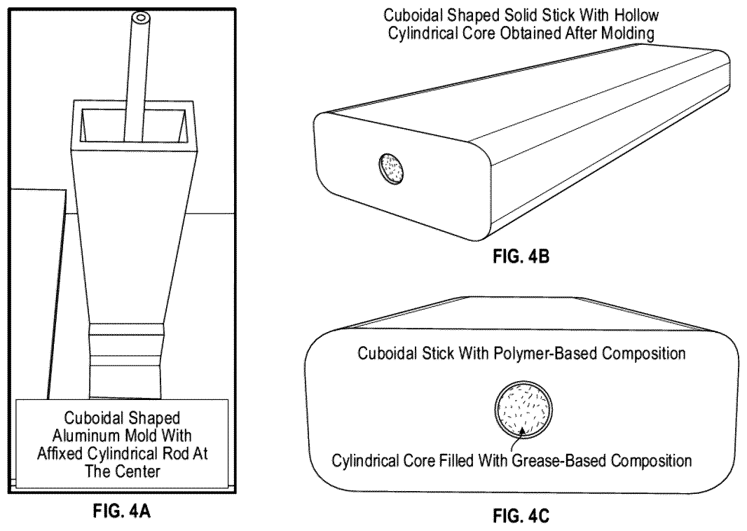

The following examples provides different compositions of the solid-liquid bi-phase lubricating device and their manufacturing using a standard molding process. To manufacture the lubricating devices with a hollow core, cuboidal shaped metallic (aluminum) molds were prepared with a cylindrical aluminum rod running through the center of the cuboidal configuration as shown in FIG. 4. The mold design allowed to manufacture sticks with cross-sectional dimensions of 6.35 cm×2.54 cm (2.5 inches×1 inches), with a central hole (core) of 1 cm (0.4 inches) in diameter. The length of the cuboidal stick and as well as of the cylindrical core was kept at 42.5 cm (17 inches) in dimension.

Example compositions 1 and 2: A high shear mixer head was attached to a heated mixing container. Upon heating the container up to 93.3° C. (200° F.), microcrystalline wax and stearic acid with and without soy wax were added and melted. Afterwards, a solid lubricant combination of graphene and graphite were added under continuous mixing. Filler materials including wood flour (saw dust), calcium carbonate, and carbon black were added and were mixed at high speeds into a homogeneous flowable paste. The compositional variations of the stick along with their hardness values are listed in Table 1.

TABLE 1
Polymer-based Compositions for The Encasing Member

| Ingredients | Composition 1 | Composition 2 | Composition 3 |
|---|---|---|---|
| Microcrystalline Wax | 30.00% | 25.00% | 0.00% |
| Stearic Acid | 13.00% | 10.00% | 3.50% |
| Soy Wax | 0.00% | 10.00% | 0.00% |
| Unsaturated Polyester | 0.00% | 0.00% | 40.00% |
| Styrene | 0.00% | 0.00% | 5.00% |
| Graphene | 2.00% | 2.00% | 2.00% |
| Graphite Flakes | 40.00% | 40.00% | 40.00% |
| Calcium Carbonate | 12.25% | 10.25% | 0.00% |
| Wood Flour | 2.50% | 2.50% | 0.00% |
| Carbon Black | 0.25% | 0.25% | 0.25% |
| MEKP DDM-9 Catalyst | 0.00% | 0.00% | 0.75% |
| Mixed dibasic acid polyester | 0.00% | 0.00% | 4.50% |
| (BASF PALAMOLL ® 652) | | | |
| Hardness (Shore D) | 38 ± 2 | 32.5 ± 1 | 61.0 ± 1 |

At 87.8° C. (190° F.), the melt compositions 1 and 2 were poured into the metallic molds and were kept inside the mold for about 20 minutes for the composition to cool down and solidify. The molds were preheated to a temperature of 37.8° F. (100° F.) for reducing thermal shock and better surface aesthetics of the sticks. Upon solidification, the composite sticks with a hollow cylindrical core were removed from the molds as shown in FIG. 3.

Example composition 3: Stearic acid was thoroughly melted and pre-mixed with styrene before being added to unsaturated polyester resin. The polymer resin mixture was kept at a temperature of 65.6° C. (150° F.) under continuous agitation. Premeasured quantities of graphene, graphite, carbon black and plasticizer (BASF PALAMOLL® 652) were then added to the polymer resin blend and was thoroughly mixed into a homogeneous formulation. The resultant polymer-based mixture along with a curing catalyst (MEKP DDM-9) was pressure filled into the pre-heated molds at 93.3° C. (200° F.). After 30 minutes, the cured sticks were removed from the molds.

After removing the cured composite sticks (composition 1, 2, and 3) from the molds, their hollow core was filled with a lithium-complex based grease at room temperature. The properties of the grease are listed in Table 2. Before filing into the stick's core, the grease was modified by mixing with 5.0 wt % molybdenum disulfide particles of 5-10 microns in size.

The grease filled stick lubricants were set to further cure and harden for at-least 12 hours in ambient conditions before performing any quality assessment tests.

TABLE 2
Properties of an Example Semi-Fluid Grease Lubricants
Grease Lubricant Properties

| Operating Temperature | −40 to 204° C. (−40 to 400° F.) |
|---|---|
| NLGI Grade | 1 |
| Thickener Type | Lithium Complex |
| Color | Black |
| Base Oil Type | PAO synthetic |
| Base Oil Viscosity, ASTM D445, cSt @ 40° C. | 220 |
| ASTM D-217: Worked Penetration, 60 strokes @ 25° C. | 280 |
| ASTM D-2265: Dropping Point | 260° C. (500° F.) |
| ASTM D-1743: Rust Preventive, 48 hrs. @ 52° C. | Pass |
| ASTM D-4048: Copper Corrosion, 24 hrs. @ 100° C. | 1B |
| ASTM D-2266: Four-Ball Wear, mm | 0.40 |
| ASTM D-2596: Four-Ball Extreme Pressure, Weld Load, kg | 500 |
| Four-ball COF (Coefficient of Friction) | 0.06 |

Using the same molding process as explained in the previous example (0039), another stick composition was manufactured. The encasing member weighing 0.38 kg (0.84 lb) (without the grease) was made of the composition as listed in Table 3.

TABLE 3
Composition of Encasing Member

| | Composition 4 | Weight |
|---|---|---|
| Ingredients | (wt %) | (lbs.) |
| Low Density Polyethylene | 40.00% | 0.34 |
| (LDPE) | | |
| Microcrystalline Wax | 5.00% | 0.04 |
| Epoxidized Soybean Oil | 10.00% | 0.08 |
| Graphite Flakes | 10.00% | 0.08 |
| Precipitated Calcium | 22.50% | 0.19 |
| Carbonate | | |
| Wood Flour | 12.00% | 0.10 |
| Carbon Black | 0.50% | 0.0042 |

| | |
|---|---|
| Hardness (Shore D) | 40 ± 2 |

The low-density polyethylene (LDPE) was melted at 137-143° C. (280-290° F.) and all remaining ingredients were then added and mixed adequately while maintaining a temperature profile of ˜121-132° C. (˜250-270° F.). The molten mixture was then poured and compressed into the aluminum molds. Upon cooling for about 5 minutes in air, the solidified stick lubricants were removed from the molds. In this case, the cross-section of the lubricant devices were 6.35 cm×2.54 cm (2.5 inches×1 inches). The length of the lubricant devices was 21. 3 cm (8.5 inches) with an inner cylindrical core of 1 cm (0.4 inches) in diameter. The inner core of the lubricant devices were filled with an aluminum complex thickened grease composition. The overall weight of the grease filled lubricant device was 0.40 kg (0.88 lbs). The properties of the grease are listed in Table 4.

TABLE 4
Grease Lubricant Properties

| Operating Temperature | −34 to +204° C. |
|---|---|
| | (−30 to +400° F.) |
| NLGI Grade | 1.5 |
| Thickener Type | Aluminum Complex |
| Base Oil Type | Naphthenic |
| Base Oil Viscosity, ASTM D445, cSt @ 40° C. | 30 |
| Pour Point ASTM D 97, ° C. (° F.) | −43° C. (−45.4° F.) |
| ASTM D-217: Worked Penetration, 60 strokes @ 25° C. | 295-310 |
| ASTM D-2265: Dropping Point | >260° C. (>500° F.) |
| ASTM D-2266: Four-Ball Wear, mm | 0.50 |
| ASTM D-2596: Four-Ball Extreme Pressure, Weld Load, kg | 500 |
| Four-ball COF (Coefficient of Friction) | 0.10 |

Embodiments of the present disclosure further relate to any one or more of the following paragraphs:

1. A lubricating device comprising: an encasing member, wherein the encasing member comprises a polymer composite, an outer surface, an inner surface, an inner space, an opening, a first end, and a second end, wherein the polymer composite has a hardness of about 20 to about 70 units in Shore D hardness scale; wherein the polymer composite comprises less than 40 wt % of a polymer; and a lubricating composition, wherein the lubricating composition is disposed on the inner surface of the encasing member.

2. The lubricating device according to paragraph 1, wherein the polymer is selected from a list comprising: a microcrystalline wax, normal alpha olefin, and stearic acid.

3. The lubricating device according to any one of paragraphs 1 or 2, wherein the polymer comprises a thermoplastic polymer, wherein the thermoplastic polymer is selected from a list comprising: soy wax, paraffin wax, polyethylene wax, polypropylene, polystyrene, high-density polyethylene, low-density polyethylene, polylactide, polyvinyl chloride, polybutylene succinate, polyamides, and acrylonitrile butadiene styrene.

4. The lubricating device according to any one of paragraphs 1 to 3, wherein the polymer comprises a thermosetting polymer, wherein the thermosetting polymer is selected from a list comprising: polyesters, vinyl esters, epoxy, polyurethane, and polysiloxane.

5. The lubricating device according to any one of paragraphs 1 to 4, wherein the encasing member further comprises a cylindrical shape.

6. The lubricating device according to any one of paragraphs 1 to 5, wherein the lubricating composition further comprises one or more inorganic solid lubricants, wherein the one or more inorganic solid lubricants is selected from a list comprising a graphene platelet, graphene oxide, 2D boron nitride, MXene, graphite, molybdenum disulfide, tungsten disulphide hexagonal boron nitride, and polytetrafluoroethylene particles, and wherein the lubricating composition has a weight percent of the one or more inorganic solid lubricants from about 0 wt % to about 10 wt %.

7. The lubricating device of according to any one of paragraphs 1 to 6, wherein the polymer composite further comprises a filler material, a catalyst, a plasticizer, a corrosion inhibitor, and an additive, wherein the polymer composite has a weight percent of the filler material from about 0 wt % to about 20 wt %, wherein the polymer composite has a weight percent of the catalyst from about 0 wt % to about 20 wt %, wherein the polymer composite has a weight percent of the catalyst from about 0 wt % to about 20 wt %, wherein the polymer composite has a weight percent of the plasticizer from about 0 wt % to about 20 wt %, wherein the polymer composite has a weight percent of the corrosion inhibitor from about 0 wt % to about 5 wt %, wherein the additive is selected from a group comprising: friction modifiers, antiwear additives, and extreme pressure additives, and wherein the polymer composite has a weight percent of the additive from about 0 wt % to about 10 wt %.

8. The lubricating device according to any one of paragraphs 1 to 7, wherein the lubricating composition comprises a semi-fluid grease-based composition, wherein the semi-fluid grease-based composition comprises a lubricant selected from a list comprising: a lithium-based lubricant, lithium-complex lubricant, calcium-sulfonate complex lubricant, aluminum-complex lubricant, mineral oil, petroleum oil, synthetic oil, and bentone based grease lubricant, and wherein the lubricating composition has a weight percent of the semi-fluid grease-based composition from about 80 wt % to about 100 wt %.

9. The lubricating device according to any one of paragraphs 1 to 8, wherein the polymer composite comprises an inorganic solid lubricant, wherein the inorganic solid lubricant comprising a 2D structured solid lubricant and a 3D structured solid lubricant.

10. The lubricating device according to any one of paragraphs 1 to 9, wherein semi-fluid grease-based composition has a National Lubricating Grease Institute consistency grade of greater than or equal to 1.

11. The lubricating device according to any one of paragraphs 1 to 10, wherein the 2D structured solid lubricant selected from the group comprising: graphene platelets, graphene oxide, 2D boron nitride, and MXenes.

12. The lubricating device according to any one of paragraphs 1 to 11, wherein the 3D structured solid lubricant is selected from the group comprising: natural graphite, synthetic graphite, molybdenum disulfide, tungsten disulphide hexagonal boron nitride, and polytetrafluoroethylene particles.

13. The lubricating device according to any one of paragraphs 1 to 11, wherein the inorganic solid lubricant has a particle size from about 1 nm to about 300 microns.

14. A method for lubricating a surface, the method comprising: contacting a surface with the lubricating device according to any one of paragraphs 1 to 13; and depositing at least a portion of the lubricating composition on the surface.

15. A method for lubricating a wheel flange-rail contact surfaces of a rail vehicle, the method comprising: contacting a surface of a wheel flange of a rail vehicle with the lubricating device of according to any one of paragraphs 1 to 14; and depositing at least a portion of the lubricating composition on the surface of a wheel flange of a rail vehicle.

One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits may be the values from the examples. Certain lower limits, upper limits and ranges appear in at least one claims below. All numerical values are “about” or “approximately” the indicated value, and consider experimental error and variations that would be expected by a person having ordinary skill in the art.

1. A lubricating device comprising:
an encasing member, wherein the encasing member comprises a polymer composite, an outer surface, an inner surface, an inner space, an opening, a first end, and a second end, wherein the polymer composite has a hardness of about 20 to about 70 units in Shore D hardness scale; wherein the polymer composite comprises less than 40 wt % of a polymer; and
a lubricating composition, wherein the lubricating composition is disposed on the inner surface of the encasing member.

2. The lubricating device of claim 1, wherein the polymer is selected from a list comprising: a microcrystalline wax, normal alpha olefin, and stearic acid.

3. The lubricating device of claim 1, wherein the polymer comprises a thermoplastic polymer, wherein the thermoplastic polymer is selected from a list comprising: soy wax, paraffin wax, polyethylene wax, polypropylene, polystyrene, high-density polyethylene, low-density polyethylene, polylactide, polyvinyl chloride, polybutylene succinate, polyamides, and acrylonitrile butadiene styrene.

4. The lubricating device of claim 1, wherein the polymer comprises a thermosetting polymer, wherein the thermosetting polymer is selected from a list comprising: polyesters, vinyl esters, epoxy, polyurethane, and polysiloxane.

5. The lubricating device of claim 1, wherein the encasing member further comprises a cylindrical shape.

6. The lubricating device of claim 1, wherein the lubricating composition further comprises one or more inorganic solid lubricants, wherein the one or more inorganic solid lubricants is selected from a list comprising a graphene platelet, graphene oxide, 2D boron nitride, MXene, graphite, molybdenum disulfide, tungsten disulphide hexagonal boron nitride, and polytetrafluoroethylene particles, and wherein the lubricating composition has a weight percent of the one or more inorganic solid lubricants from about 0 wt % to about 10 wt %.

7. The lubricating device of claim 1, wherein the polymer composite further comprises a filler material, a catalyst, a plasticizer, a corrosion inhibitor, and an additive, wherein the polymer composite has a weight percent of the filler material from about 0 wt % to about 20 wt %, wherein the polymer composite has a weight percent of the catalyst from about 0 wt % to about 20 wt %, wherein the polymer composite has a weight percent of the catalyst from about 0 wt % to about 20 wt %, wherein the polymer composite has a weight percent of the plasticizer from about 0 wt % to about 20 wt %, wherein the polymer composite has a weight percent of the corrosion inhibitor from about 0 wt % to about 5 wt %, wherein the additive is selected from a group comprising: friction modifiers, antiwear additives, and extreme pressure additives, and wherein the polymer composite has a weight percent of the additive from about 0 wt % to about 10 wt %.

8. The lubricating device of claim 1, wherein the lubricating composition comprises a semi-fluid grease-based composition, wherein the semi-fluid grease-based composition comprises a lubricant selected from a list comprising: a lithium-based lubricant, lithium-complex lubricant, calcium-sulfonate complex lubricant, aluminum-complex lubricant, mineral oil, petroleum oil, synthetic oil, and bentone based grease lubricant, and wherein the lubricating composition has a weight percent of the semi-fluid grease-based composition from about 80 wt % to about 100 wt %.

9. The lubricating device of claim 1, wherein the polymer composite comprises an inorganic solid lubricant, wherein the inorganic solid lubricant comprises a 2D structured solid lubricant and a 3D structured solid lubricant.

10. The lubricating device of claim 8, wherein semi-fluid grease-based composition has a National Lubricating Grease Institute consistency grade of greater than or equal to 1.

11. The lubricating device of claim 9, wherein the 2D structured solid lubricant selected from the group comprising: graphene platelets, graphene oxide, 2D boron nitride, and MXenes.

12. The lubricating device of claim 9, wherein the 3D structured solid lubricant is selected from the group comprising: natural graphite, synthetic graphite, molybdenum disulfide, tungsten disulphide hexagonal boron nitride, and polytetrafluoroethylene particles.

13. The lubricating device of any one of claim 9, wherein the inorganic solid lubricant has a particle size from about 1 nm to about 300 microns.

14. A method for lubricating a surface, the method comprising:
contacting a surface with the lubricating device of any one of claims 1 to 13; and
depositing at least a portion of the lubricating composition on the surface.

15. The method for lubricating surfaces of claim 14, wherein the surface is:
of a wheel flange of a rail vehicle.

16. A lubricating device comprising:
an encasing member, wherein the encasing member comprises a polymer composite, an outer surface, an inner surface, an inner space, an opening, a first end, and a second end, wherein the polymer composite has a hardness of about 20 to about 70 units in Shore D hardness scale; wherein the polymer composite comprises less than 40 wt % of a polymer; and
a lubricating composition, wherein the lubricating composition is disposed on the inner surface of the encasing member,
wherein the lubricating composition further comprises one or more inorganic solid lubricants, wherein the one or more inorganic solid lubricants is selected from a list comprising a graphene platelet, graphene oxide, 2D boron nitride, MXene, graphite, molybdenum disulfide, tungsten disulphide hexagonal boron nitride, and polytetrafluoroethylene particles, and wherein the lubricating composition has a weight percent of the one or more inorganic solid lubricants from about 0 wt % to about 10 wt %, and
wherein the polymer composite comprises at least one of a thermoplastic or thermosetting polymer.

17. The lubricating device of claim 16, wherein the polymer composite comprises an inorganic solid lubricant, wherein the inorganic solid lubricant comprises a 2D structured solid lubricant and a 3D structured solid lubricant.

18. The lubricating device of claim 17 wherein the 2D structured solid lubricant selected from the group comprising: graphene platelets, graphene oxide, 2D boron nitride, and MXenes; and wherein the 3D structured solid lubricant is selected from the group comprising: natural graphite, synthetic graphite, molybdenum disulfide, tungsten disulphide hexagonal boron nitride, and polytetrafluoroethylene particles.

19. The lubricating device of claim 16 wherein the polymer composite further comprises a filler material, a catalyst, a plasticizer, a corrosion inhibitor, and an additive, wherein the polymer composite has a weight percent of the filler material from about 0 wt % to about 20 wt %, wherein the polymer composite has a weight percent of the catalyst from about 0 wt % to about 20 wt %, wherein the polymer composite has a weight percent of the catalyst from about 0 wt % to about 20 wt %, wherein the polymer composite has a weight percent of the plasticizer from about 0 wt % to about 20 wt %, wherein the polymer composite has a weight percent of the corrosion inhibitor from about 0 wt % to about 5 wt %, wherein the additive is selected from a group comprising: friction modifiers, antiwear additives, and extreme pressure additives, and wherein the polymer composite has a weight percent of the additive from about 0 wt % to about 10 wt %.

20. The lubricating device of claim 16 wherein the inorganic solid lubricant has a particle size from about 1 nm to about 300 microns.
